(19) United States
(12) Patent Application Publication
(10) Pub. No.: US 2004/0205547 A1
(43) Pub. Date: Oct. 14, 2004

(54) Annotation process for message enabled digital content

(76) Inventors: Kenneth Charles Feldt, Mechanicsville, VA (US); Mikhail I. Passov, Richmond, VA (US)

Correspondence Address: John H. Thomas, P.C., 1561 East Main Street, Richmond, VA, 23219, US

(21) Appl. No.: 10/820,908

(22) Filed: Apr. 8, 2004

Related U.S. Application Data
(60) Provisional application No. 60/462,436, filed on Apr. 12, 2003.

(51) Int. Cl. G06F 17/00

(52) U.S. Cl. 715/512

(57) ABSTRACT

A method enhances electronic messaging techniques applied to interactive exchanges of complex subject matter expressed through such diverse content as text, mathematic formulae, chemical expressions, and graphics. The method includes processes and techniques to (a) communicate abstract concepts through animated sequences of mathematic formulae, scientific expressions, and data visualizations; (b) encode such expressions and visualizations in a way to facilitate their inclusion in messages exchanged by readers during educational discourse, and (c) transfer and render such expressions, visualizations, and annotations to other users in the form of digitally transmitted display pages. The method includes a technique to encode digital content in a fashion to allow for the creation of text messages and the convenient inclusion of annotations to reference both textual, and non-textual media elements.

This application claims the benefit of U.S. Provisional Application Serial No. 60/462,436, filed Apr. 12, 2003.

The field of the invention is a method for the annotation of electronically displayed documents. The present annotation method enhances interactive exchanges of complex subject matter expressed through such diverse content as text, mathematical formulae, chemical expressions, and graphics.

### BACKGROUND

I. The Current Role of Technology in Skill Development

The development of a skill has evolved into a general sequence in which a subject matter expert (such as a teacher) manages the delivery of subject matter to students. The objective of this delivery is to enable the student to master some problem solving or analytical skill. Electronic media as well as ‘traditional’ hardcopy media have been employed extensively to support the delivery of instructional information and, to some extent, to illustrate examples of how to solve problems in the areas of mathematics and the physical sciences.

To date, there has been little put in place to assist the student in his/her ability to interactively discuss and better explore topics and solution sequence in subject areas rich in non-textual lexicon such as mathematics, chemistry, and physics. As a result, technology has not yet dealt with one of the key aspects of learning: the very real interaction among students and teachers who discuss the solution sequence in an effort to master the perspective required if a skill is to be something more than a mechanical response void of understanding. Students may use e-mail, instant messaging, and telephone to talk about problem examples and solutions, they may even be able to use e-mail to include a URL linking to a web page whose content contributes to the sender's intent. But there exists an opportunity to improve on this technique that forces a sender to build a message of pointers to where other content lies.

A brief background on the use of traditional and electronic media in academic settings includes the following:

A. Traditional Textbook Media

Many students in secondary school and undergraduate are exposed to coursework in mathematics (algebra, statistics, calculus) and the physical sciences (physics, chemistry). The traditional pedagogy involves classroom lecture that follows material largely contained in a paper textbook. The textbook is divided into chapters, each of which contains example problems and end of chapter review problems. Students review such exercises at home in order to practice the skill being presented.

Any interaction among students or between students and teachers is limited to personal interaction in a common setting such as a classroom, or through electronic forms such as telephone and e-mail in which students talk about the content housed within the book. In either case, the audio words transferred by phone, or written words sent by e-mail, capture very little of the actual content delivered by the book.

B. ‘Add On’ Media

Some books include a CD-ROM for additional study or practice materials. Such content often supplements the traditional text with exercises, experiments, graphing routines and other interactive electronic exercises. Such tools add value in enhancing the static book content through a richer media model; there are also techniques that better deliver exercises and review questions through automated repetition and quiz generation. As stand alone media, however, such tools still do not add value to the communication process among students and teachers.

C. Internet Support & E-Mail

Some instructors have access to publisher web sites that allow the construction of customized texts for use in the classroom. Other services available over the internet include remote access to grades and class assignments. Some texts include internet companion sites for outlines and interactive review materials. All these tools may be referred to as ‘broadcast’ forms in which information radiates from a central location (e.g. the school system or the publisher) out to students. These tools take an incremental step to improving the communication tools used by students by building e-mail links between student and teacher. These exchanges, however, remain limited to short text messages that reference other media (e.g. an e-mail describing what a graph looks like).

Some more sophisticated e-mail packages allow the inclusion of image data in the body of the message, and others even allow the rendition of complete HTML pages to be transferred to recipients. While such tools help add impact to the messaging process, the resulting communication results in little more than a large ‘chunk’ of media that may be passed from sender to recipient; that media itself offering little, if any, opportunity for interactivity.

D. Online Tutoring

One form of interaction that breaks the ‘broadcast’ mode is a form of online tutoring offered by companies delivering web-based conferencing tools. While these techniques take a step forward in building links of communication between tutors and students, these methods also rely heavily on traditional e-mail, video conferencing, and in some cases, the use of digitizer tablets to allow transfer of free-form sketches.

E. Other Media Annotation Tools

There are also some media annotation tools already in use outside the field of education. Tools in the graphic arts and video production allow designers and producers to highlight a specific portion of an image, or video frame, and exchange information regarding elements of the composition such as color, lighting, or other physical attributes of the frame. These tools, however, do not have the context of meaning behind what is being annotated, nor do they lend themselves to an interactive messaging paradigm facilitated by conventional electronic mail and newsgroups.

II. Prior Art

In the context of this application the term ‘document’ refers to any representation of media suitable for interpretation by an individual. Document files, therefore, may include text, image, graphics, video, and audio media that is relevant to a user of the document.

There are numerous inventions related to ‘document-centric’ annotation techniques. That is, in the field of document creation, review, and version control, numerous tools are in place to support text-based document annotation—the process of selecting portions of a document and ‘attaching’ freehand or typed commentary on behalf of a reader. Many of these techniques are applied to the problem of collaborative document design and review.

Some inventions such as those in the field of Computer Aided Design (CAD), and graphic animation techniques are designed to aid in collaborative review or to assist the design process. Disclosures exist that reference the ability to graphically draw selection boxes around graphic representations of structures; techniques have also been discussed to assign characteristics to groups of animated graphics for the purpose of engineering simulation.

There are also several disclosures relating to ‘media-centric’ annotation techniques—the ability to attach annotations to audio or video data files for the purpose of providing supplementary observations or commentary regarding the media file content. A great deal of work has been done to describe the annotation of video data frames, the attachment of notes to time-index keyed positions in temporal media, as well as the creation of hypertext documents synchronized with video media for delivery to a user.

There are also numerous disclosures regarding how digital annotations are to be displayed in concert with the media being annotated, including disclosures on how to ‘morph’ displayed text around annotation glyphs, how to re-organize displays on personal digital assistants to create notes written with the help of a stylus, and how to display annotation notes through the use of video ‘planes’ that ride transparently above the base document. There is also a great deal of work that describes how to electronically store annotation text separate from the base media, and to register such annotations with specific versions of document content.

A great deal of work also exists in the field of collaborative exchanges facilitated by computer networks. Many of these disclosures relate to virtual white boards (groups of collaborators viewing a computer generated white board that is shared by others); other work also exists in the areas of shared computer displays that connect members of learning communities. These disclosures generally focus on a few broad areas of interest: (a) how electronic annotations are stored, managed, and retrieved, (b) how the ‘markup’ associated with an annotation is managed and displayed, and (c) how documents and annotations are synchronized and distributed.

III. Prior Art Shortcomings

But despite such advances, there are still opportunities to improve the ability to integrate disparate media types into interactive discussions in a cost-effective, convenient fashion. There is a need to better encode textual and non-textual information so that it is easily included in message annotations for the purpose of computer based interactive discussions.

Specifically, there is a need to better accommodate message annotation creation and exchange as applied to documents, animations, and technical notations, in order to improve the effectiveness of online dialogue:

1. Much prior work takes a ‘document-centric’ or ‘media-centric’ perspective—a user is viewing a document, viewing video, or listening to audio, can review and create annotations attached to that document or media. There is a need for a ‘message-centric’ perspective—individuals create and exchange messages about a topic; the messages include annotations (references) to any supported document element. The message ‘thread’ is therefore not set by document structure, but is a continuum of personal exchanges that include randomly accessed document elements.

2. Annotation techniques should make use of a technique to provide a ‘table of contents’ to identify key textual and non-textual document elements. For example, if a user wanted to attach a note to the ‘slope’ of an equation, s/he would be well served with a quick index of where, in the document, the slope is displayed. This is particularly helpful in cases where documents include a complicated arrangement of text, graphics, and animation.

3. A user may want to annotate an animation at a specific point in time; it is also useful if recipients of the annotation message view the animation at the correct time index along with the annotation message with a minimum of interaction with the display system.

4. Annotation techniques will be improved when the attachment process does not rely on the spatial characteristics of the document being annotated (e.g. an annotation attached to a chemical equation that might be presented in a variety of font sizes, or even positions within a document).

### BRIEF DESCRIPTION OF THE DRAWINGS

FIG. 1A is an example of a pseudo data structure for a linear equation having meta-media tags.

FIG. 1B is an example of a pseudo data structure for a visualization of a linear equation having meta-media tags.

FIG. 2 is an example of the relationship between meta-media identifiers and various forms of content such as visualization and expression.

FIG. 3 illustrates the rendition process through MathML and SVG files.

FIGS. 4A and 4B display possible computer interfaces to attach annotations to elements. FIG. 4A uses a list (table of contents) approach. FIG. 4B uses a manual selection approach.

FIGS. 5A and 5B illustrate a possible interface used to annotate and exchange annotated content between users.

FIGS. 6A and 6B illustrate a summary of the operation of the method when applied to a text book add-on project.

FIG. 7 illustrates a collection of technologies that could be used to implement the methods herein.

FIG. 8 represents a conceptual view using the unified modeling language to represent the data structures or classes that could implement the methods described herein.

### TERMS AND USAGE

Addressability—the state of displayed content that indicates its capacity to be annotated by a user.

Animation—a collection of text, graphics, or images displayed in succession to stimulate interest or provide the illusion of motion.

Annotation Management Software—the algorithms implemented in user interface software that manages the creation of annotations, creation of text anchors, the logical attachment of text anchors to display elements, and the graphical highlighting of text anchors and the associated content elements.

Annotation message—A textual comment generated by a user that includes annotation elements such as (a) the written annotation text note, (b) at least one keyword to serve as an identifier or the annotation, and (c), 0, one, or more text anchors that are logically and visually connected to display page elements such as text, expressions, or visualizations.

Annotation text—a text note entered by a user of the invention that expresses a question or observation about an existing electronic document, or about annotation messages s/he has received.

Base content—the presentations serving as the basis for an annotated message exchanged between users of the invention.

Corpus—a collection of material dedicated to a single subject.

Display page—a single two-dimensional space onto which text, animation, graphics, or other visual media is rendered.

Discussion thread—a series of text messages submitted by computer users as part of a topic of discussion.

Explanation—textual content of the verbiage used to describe the presentation topic.

Expression—a display item rendered in a non-textual lexicon. Examples of expressions include mathematic formulae, chemical formulae, and measures of music.

Element—the primitive component used to build expressions or graphic visualizations. Examples of elements may be ‘line’, ‘exponent’, ‘coefficient’, ‘parabola’, etc.

Glyph—a visual mark used to convey information in a non-verbal fashion.

Graphic—a visual representation generated by drawing, either through human free-form, or through computer aided graphics

Highlight—a visual indicator emphasizing an element's spatial location on a display page. Highlights connect display page elements with textual anchors included in annotations.

Image media—a visual representation of some object.

Javascript—a scripting language that enables designers to add interactivity to traditional web pages.

Meta-media—encoded information about the media included in electronic content; in this invention, meta-media identifiers provide the association between abstract (non visual) concepts of a presentation and the visual elements viewed by a user of the invention.

Presentation—A content database entry consisting of a collection of any combination of graphics, animations, visualizations, image, audio, or video designed to communicate a concept.

Presentation Topic—The topic or subject matter being communicated through the presentation.

Subject item—any element, expression, glyph, graphic or image media that is adapted to be encoded in a computer readable format.

Text anchors—selections of annotation text that point to display page elements through a highlight graphic.

Time-based (temporal) media—any form of media that consists of a sequence of images or sound. Examples include video, animations, or audio.

URL—universal resource locator—a textual link to internet resources such as web pages and digitized media

Visualization—a graph representing a visualized form of the relationship existing between two or more variables.

XML—Extensible Markup Language—a standard method of encoding data in the form of a text document consisting of a hierarchy of nodes.

### DETAILED DESCRIPTION

This invention describes a technique in which textual messages include annotations that reference, and display, both textual and non-textual document elements such as formula elements, graphs, and illustrations. This disclosure has particular relevance for electronic publishing and collaborative learning, particularly in settings dealing highly technical material such as content found in technical publishing, scientific education, or engineering design.

As the objective of this invention is to facilitate the ability to integrate text messages with annotations referencing document media, it is helpful to (a) consider how such document media would be organized and encoded, (b) propose a method to ‘treat’ such content to facilitate inclusion in message annotations, (c) describe how such document content would be displayed, (d) how a reader of the document content would generate a message with annotations to document content, and (e) how such annotated messages would be exchanged with others.

A. Organizing and Encoding Document Content

An individual who publishes information through electronic documents often organizes information into presentation topics (e.g. linear equations, matrix multiplication, a given chemical reaction). These topics may be conveyed to users through any combination of traditional text narratives, symbolic expressions (formulae) consisting of coefficients, exponents, and glyphs representing molecular bonds, and data visualizations such as plots representing functions, axes, and legends.

To deliver such presentations electronically, the publisher must initially encode these content types into base media, digital files that represent the initial capture of the publisher's ideas into media suitable for use by a computer system. The invention provides for the base media to include textual tokens, or meta-media identifiers, that associate a presentation's concepts with the visual glyphs being rendered. The assignment of meta-media ID's to elements of the base media files, makes such media message-enabled such that students and teachers can readily relate messages that include annotations referencing such visual elements as part of an interactive exchange. The resulting content is organized into a coherent database and distributed among users. The annotation management software is used to manage all elements of the creation and display of message annotations.

The sequence is further described as follows:

B. Message-Enabled Electronic Digital Content is Developed

Expressions such as mathematic, physics and chemical formulae consist of a collection of graphic elements assembled to represent some relationship or property. An algebraic expression such as “y=0.7x+7” consists of the elements “y”, “0.7x”, the “+” operator, etc. Similarly, visualizations consist of elements as part of the complete graphic. A graph of a linear equation would consist of separate elements for the mathematic function being plotted, the axes, and the graph legend.

The first step of the method involves the encoding of presentation topics into base media files. Examples of such an encoding process include the creation of MathML (XML files used to encode math formulae), or the authoring of multimedia files using commercial tools such as Macromedia Inc.'s Flash® tool. Relevant subject items in an expression or visualization are then assigned text identifiers that give meaning or context to the data structure contained in the base media file. That is, if a media file contains the encoded form of the linear equation ‘y=0.7x+7’, the file would include a data primitive for the variable ‘x’, and (for example), a meta-media identifier as “independent variable”. This assignment provides a human readable point of reference to facilitate reference of the content in interactive exchange. The base media file for such mathematic formula would include the information needed for a computer system's rendering engine to display the formula, along with a collection of meta-media identifiers such as “slope”, “y-intercept”, and “independent variable”. Annotation management software can display a list of meta-media identifiers to facilitate selection of the “y-intercept” in a formula or on a graph, allowing the student to create text note that includes an annotation referencing the “y-intercept” element.

The ‘message enabling’ of this base content includes the following steps:

1. Encoding the expressions in a computer readable base media file.

2. Adding ‘meta-media identifiers’ to provide context to the expression and its component elements. Examples of such identifiers in an instructional setting for mathematics may be:

‘Left hand side (lhs)’, ‘right and side (rhs)’ of an equation

‘Slope’ of a linear equation

‘Radius’ of the unit circle

‘Y-Intercept’ of a linear equation

‘X-Intercept’ of a parabola

‘Byproduct’ of a chemical reaction

Variable representing mass of an object the formula for acceleration

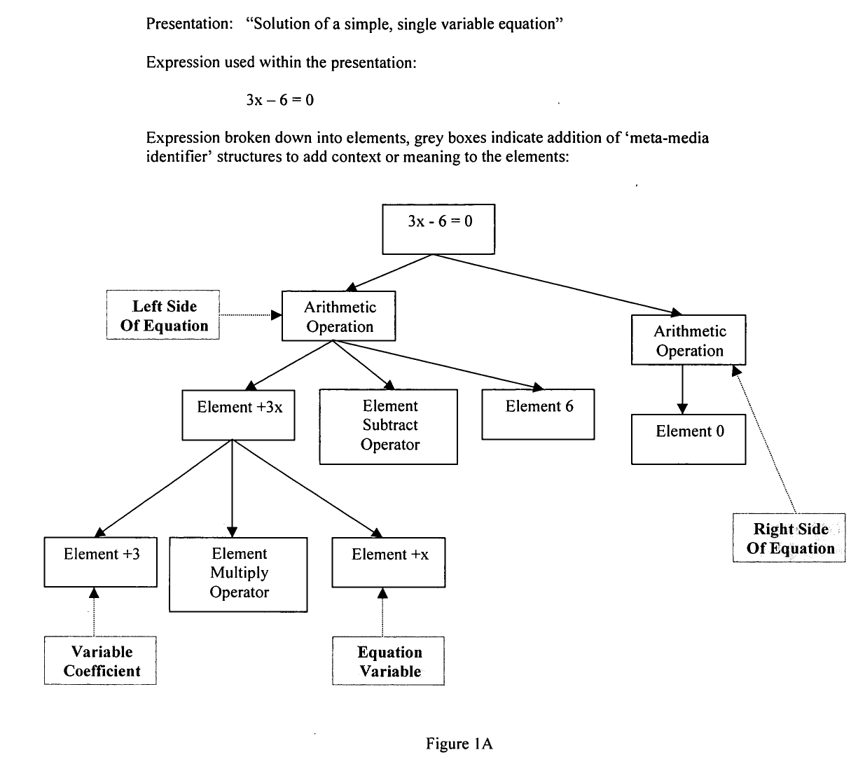

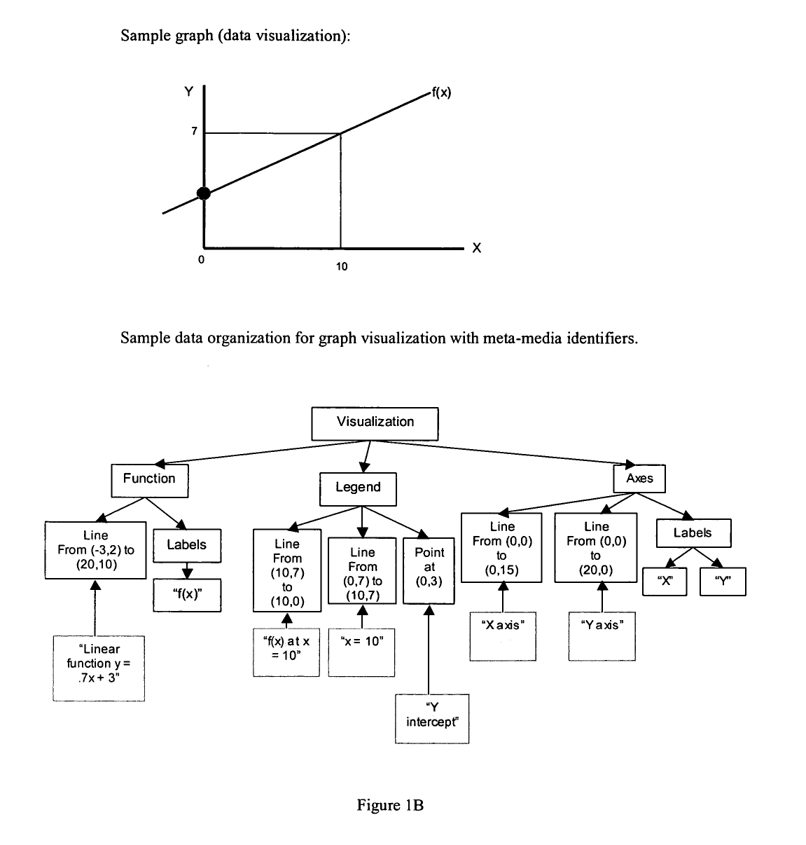

(An example of a pseudo data structure for a linear equation with such meta-media tags is shown in FIG. 1A.)

3. Developing relevant visualizations (graphs)

4. Adding ‘meta-media’ information to the visualization elements to provide context to the visualization. Examples of such information includes:

Identification of mathematic functions

Intersection of functions with axes

Regions under a curve

Regions of intersecting functions

(An example of a pseudo data structure for a visualization of a linear equation with such meta-media tags is shown in FIG. 1B.)

5. Meta-media identifiers may also be assigned to entire assembles individual expressions that are collected into a sequence that explains a series of problem solving steps. Steps associated with an expression may be assigned a meta-media identifier that is descriptive (e.g. “Step 1: divide both sides of the equation by 3”).

6. Meta-media identifiers may also be assigned to graphic elements, or to collections of elements, that are presented sequentially as in the presentation of animated graphs. (e.g. “The function equals 7 when x=10”).

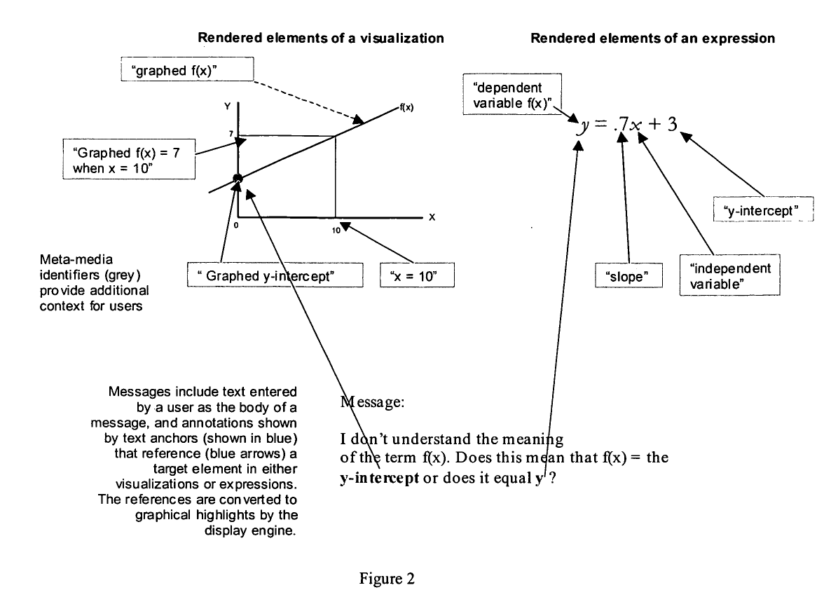

The resulting content (expression, visualization, animation, & graphics) represent the author's presentation associated with the key concept being covered. Presentations may consist of any combination of content that effectively communicate the key concept. That is, a presentation may include a sequence of expressions as well as animated graphics, or image, audio, or video media. FIG. 2 summarizes an example of the relationship between meta-media identifiers and various forms of content such as visualizations and expressions.

C. Rendering

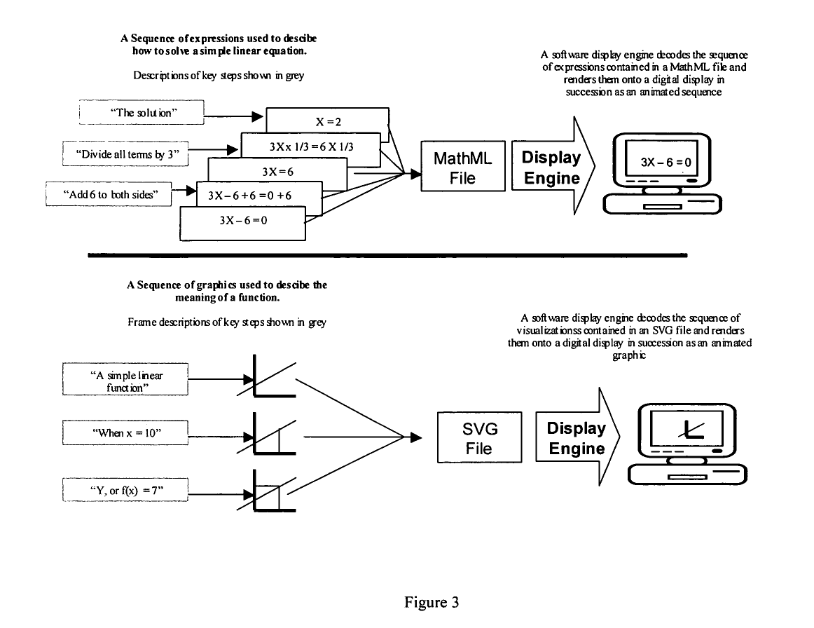

The method presumes the use of any commercially available media rendition tool to carry out the low level rendition to the user. This rendition process includes the necessary ‘primitive’ drawing playback of all expressions, visualizations, and animation media associated with the presentation, as well as the display of the meta-media references embedded in the content. Examples of such rendering engines include Macromedia's® Flash player for graphics, or the Mozilla-based web browser support for MathML rendering. FIG. 3 illustrates the concept through MathML and SVG files.

D. Annotation Process

A user may use a personal computer, electronic book, or personal digital assistant to view the presentations. In addition, the user may ‘post’ a textual question to other users of the invention, and annotate portions of the question with references to any message enabled content. The process through which the student attaches annotations to content includes the ability to play back animations, advance forward and backward to any segment, and attach an the annotation to the expressions, visualizations, or other media of any given segment of the presentation. The annotation process includes:

1. The ability to specify portions of the base content to be used to annotate a text message.

2. The ability to advance content that consists of time-based media to a specific segment, that is, if the base content includes digitized animation, the ability to advance to a given time-index of the animation.

3. The ability to view a list of all meta-media identifiers in a ‘table of contents’ form to facilitate the attachment to annotations.

4. The ability to manually select (e.g. click on, mouse-drag over) message enabled content to facilitate the attachment to annotations.

5. The ability to attach to these highlighted elements identified in (3) and (4) to annotations of textual comments expressing the annotator's question, observation, or comment to be shared with others.

6. The linking of the highlighted elements described in (3) and (4) to an anchor keyword in the annotation text described in (5).

7. The ability to repeat the annotation connection process any number of times for a given text message.

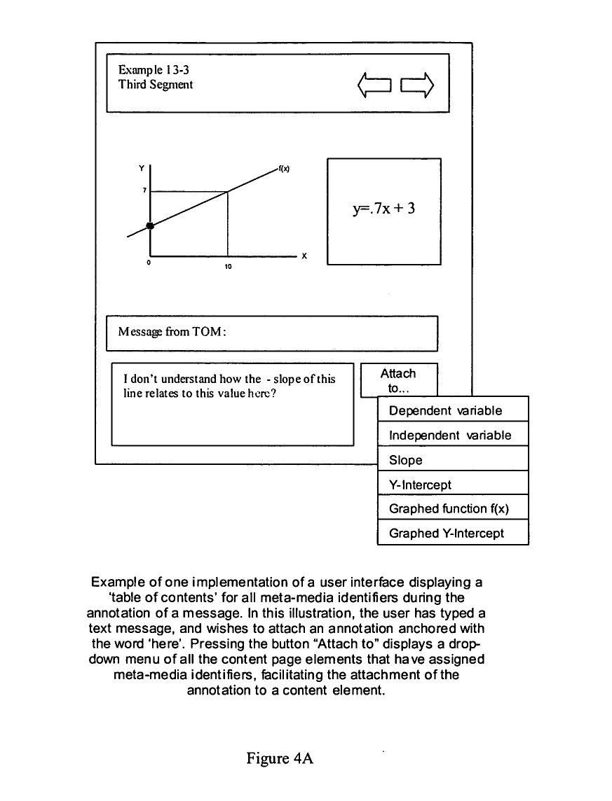

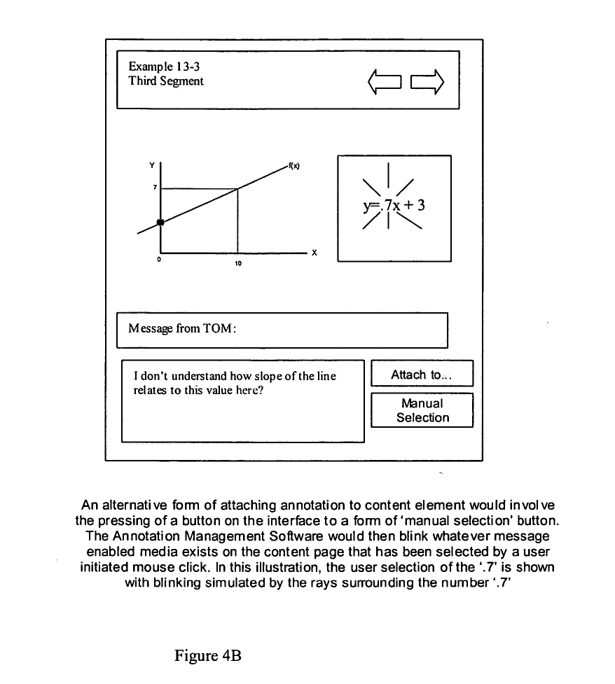

A representation of possible computer interfaces to attach annotations to elements using either a list (table of contents) approach or through manual selection is shown in FIGS. 4A and 4B.

E. Message Exchange

Annotated messages may be created on any digital media capable device and transferred to other users of the invention. The invention includes the processes in which:

1. The ability of a message recipient to construct a reply message, using the same techniques listed in section (d), building upon any available web enabled base content, or based upon the annotation message received from the sender.

2. The transfer of the annotated message and base content to a recipient.

3. The reconstruction of the base content as will as the sender's annotation and highlights.

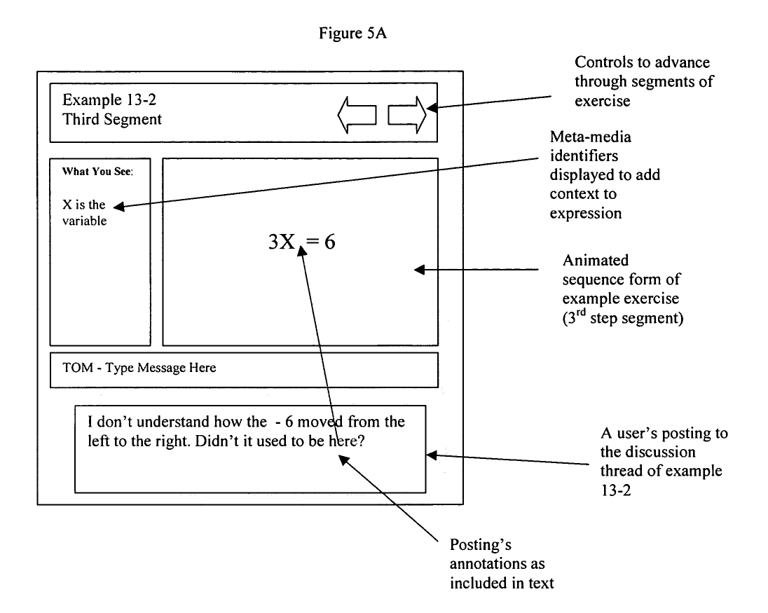

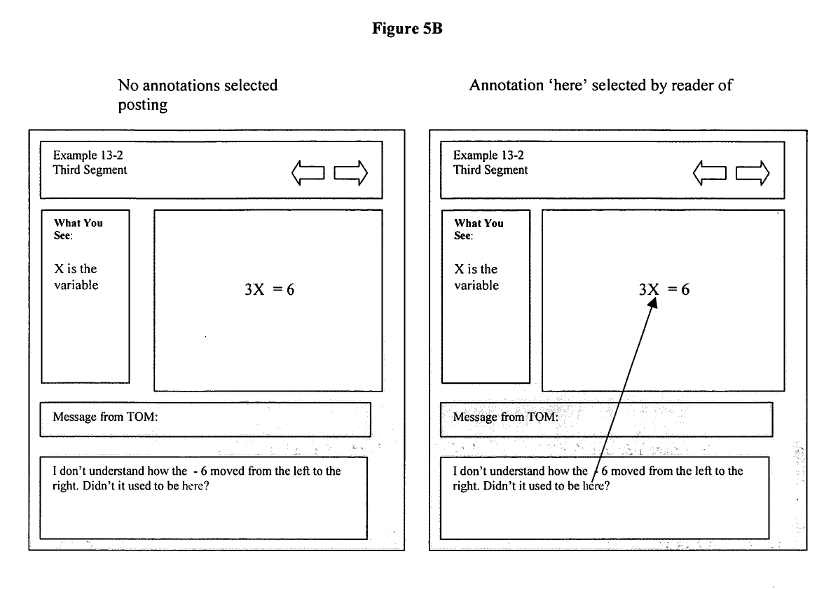

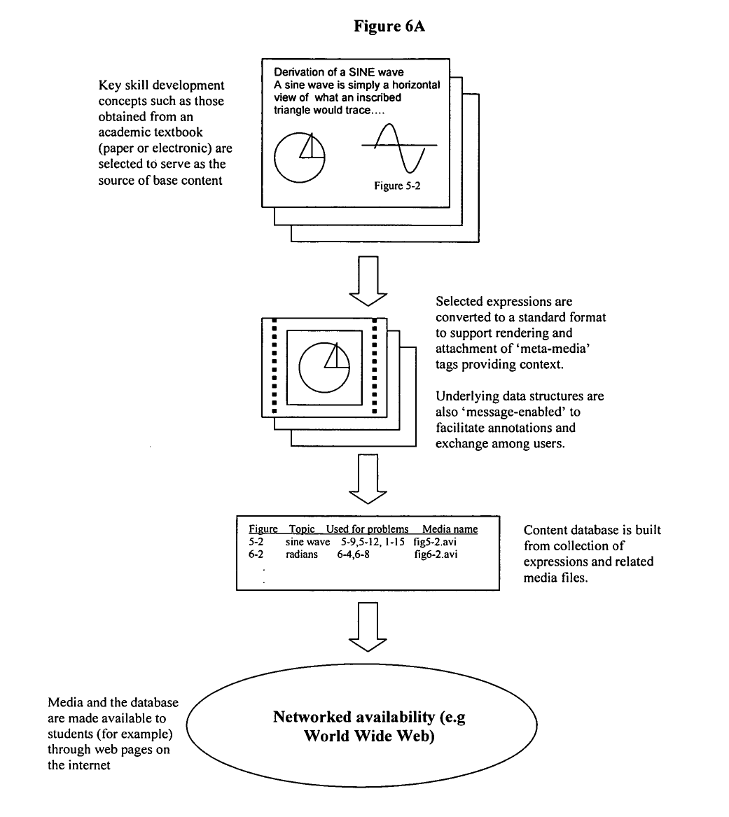

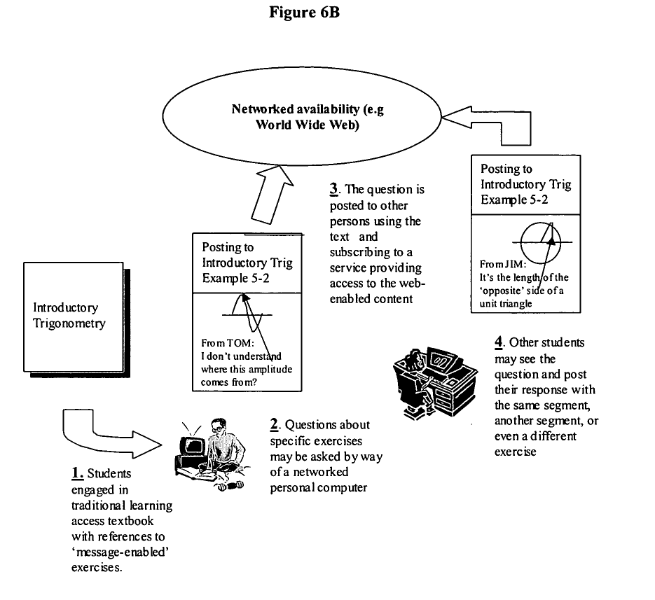

FIGS. 5A and 5B illustrate a possible interface used to annotate and exchange annotated content between users. Students may attach as many annotations to their message ‘posting’ as is feasible by the display technology. FIGS. 6A and 6B illustrate a summary of the operation of the method when applied to a textbook add-on project. This sketch illustrates the process in which base content is web enabled, students use the content to construct annotation based messages for transfer to peers, and recipients respond to the sender using the same techniques.

F. Example of One Method of Implementation

The method allows a person to create messages that include annotations attached textual and graphic representations of the underlying concepts displayed in disparate media. The invention also covers the process in which those links are used to assemble a unique display page transferred to recipients through such common methods as electronic mail and electronic newsgroup postings.

An implementation of this invention provides a supplementary service to text-based content such as textbooks or electronic books used in academic settings. This content contains a corpus of key concepts covering subjects such as mathematics, the physical sciences, or other subjects in which symbolic notation, mathematic formulas, derivations, visualization, or audio presentation plays a major role. The books also contain a large number of example and summary problems (exercises) used by students to practice mastery of some analytical skill.

The invention would be embodied as an internet-based service through which students use an online-messaging service in support of after-school study. The service accesses content ‘pages’ representing animated versions of problem solutions, chapter examples, or other illustrative media. Students may create text messages that include annotations referencing elements present in frames of the animation; students highlight portions of text content, elements of forumulae, or portions of a graph, and send the annotated messages to others in newsgroup-like threads who then view a single display page reconstructed from the highlights and links established by the sender. Students may attach any number of annotations to a text message, and each annotation may reference different content elements that exist anywhere in the available material, allowing a message's annotations to reference any number of different content page elements.

One possible implementation would encode all data and annotations in formats consistent with the eXtensible Hypertext Markup Language (XHTML). This implementation would build on the ability of existing web browsers to make available to scripts an interface that describes the document's structure and content. The interface used in this implementation is known as the Document Object Model (DOM).

This section further describes one possible implementation as applied to such a textbook add-on.

1. Content Development

Developers would select the example problems and review problems that hold the greatest value for students. These example problems would include mathematic expressions, textual presentations, and graphic visualizations.

Complicated mathematic expressions would be encoded as MathML document data.

An example of a simple mathematic expression encoded in the standard MathML syntax follows:

```
<math xmlns=“http://www.w3.org/1998/Math/MathML” >
  <mrow mathsize=“30pt” >
    <mn >4</mn><mo>+</mo>
      <mn>7</mn><mo>&CenterDot;</mo><mn>2</mn>
      <mo>+</mo><mn >10</mn><mo>&divide;
      </mo><mn>2</mn>
  </mrow>
</math>
```

Collections of expressions used to illustrate sequential problem solutions would be included as MathML portions of XHTML documents. That is, a sequence of math formulae used to illustrate a problem solving technique would be assembled into a series of MathML sections of the larger XHTML document. In addition, textual narratives in the form of simple XHTML text would be added to provide additional explanatory background to the solution technique. This embodiment places such text into an XHTML's div element:

<div class=‘narrativeBox’ style=“position:absolute; text-align:right;
top:Opx; left:Opx; width:290px; height:600px”>
<br></br>

Because the value of <i>a</i> is positive, the parabola will open upward. The axis of symmetry goes through the vertex, so the equation of the axis of symmetry is x=2.

<br></br>

<br></br>

To draw the parabola, we pick 2 values of <i>x</i> on each side of the axis of symmetry, substitute the values into the original equation, and solve for the values of <i>y</i>. In this case, we select the values of 1, 0, 3, and 4 for values of <i>x</i> and solve for <i>y</i>.

<br></br>

<br></br>

We now have four points that can be used to plot the parabola.

</div><!—end narrativeBox→

Simple graphics would be rendered using a standard graphics language such as the Scalable Vector Graphics Specification. Animation of graphics could be accomplished by combining SVG and the Synchronous Multimedia Integration Language (SMIL). A Sample parabolic function would be encoded in the SVG standard using the bezier curve data structures included as the ‘path’ object:

```
<g class=“MathFunction”>
    <path class=“F2”
        d=“M8,20 Q5,-16 2,-16 T-4,20”
        style=“fill:none; stroke-width:0.1;”/>
</g>
```

Alternately graphic animations would be produced using such tools as a Flash® development kit from Macromedia, Inc. Text narratives would similarly include meta-media information as class and id attributes of a div HTML element that contains the text.

2. Subject Items and Meta-Media Identifiers

The invention enhances the utility of simple media by incorporating the concept of subject items, distinct components of the media that are relevant to understanding the key concept covered by the media in the presentation topic. XHTML documents that carry the previously described content also include data elements that provide only supporting roles in the display of a document. For example, a visualization would include SVG constructs not only for the mathematic functions that are essential to the presentation topic, but also the data for background display grids, axes, and even graph labels. In addition, it would be of value to have some scripting process provide a ‘table of contents’ type of construct to the invention user to facilitate the creation of messages with annotations referencing content elements. This embodiment of the invention uses the standard “id” (for identifier) attribute of DOM elements to implement both the addressability and to add context to individual elements. The use of encoding consistent with the DOM standard would allow annotation management software scripts to ‘search’ through the document content to act appropriately when document elements possessing pre-defined id attributes are found.

Addressability refers to the ability of the annotation management software to make the distinction between document elements that are essential to the presentation topic and those elements used to merely support the decoding or display of the content. In this implementation, the designer would add an id with a pre-defined pattern of characters to allow interface software to choose a course of action if the invention user ‘clicks’ on a displayed element. (Most implementations of web browsers provide software with the support to translate between a visual glyph, and the DOM element represented by the glyph.)

The mathematic expression previously described would now be encoded as:

```
<math xmlns=“http://www.w3.org/1998/Math/MathML” >
  <mrow mathsize=“30pt”>
    <mn id=“Addressable.01” >4</mn><mo id=“Addressable.02” >+</
    mo>
        <mn id=“Addressable.03” >7</mn><mo id=“Addressable.04”
      >&CenterDot;</mo><mn id=“Addressable.05” >2</mn>
    <mo id=“Addressable.06” >+</mo>
      <mn id=“Addressable.07” >10</mn><mo>&divide;
    </mo><mn id=“Addressable.08” >2</mn>
  </mrow>
</math>
```

If a user of the invention uses a computer mouse to select a displayed element by clicking on a rendering of the element, pseudo-code of the annotation management software could make a decision of whether or not to graphically ‘blink’ the element, indicating that the selected item is addressable and able to be attached to annotations:

targetElement=

```
    getUserSelectedDomElement( );
if (targetElement.id.beginsWith(“Addressable”)) {
    targetElement.doBlink( );
}
```

The same technique would be applied to SVG elements providing a visualization of the presentation.

The term ‘context’ refers to the use of the id attribute to provide meta-media information that is useful in providing users of the invention with meaningful information regarding a selected content element. Such ‘meaningful information’ would be of value if the annotation management software script would be responsible for building a table of contents type of interface for selected elements. For example, the following SVG declaration describes a horizontal line being drawn on a graph to represent the intersection of the Y-axis with a mathematic function. In this case, a ‘class’ attribute has been added and the meta-media information is encoded in the id attribute, and is used to provide to user's a textual description of that line:

<line class=“tableOfContentEntry” x1=“0”y1=“7” x2=“10”, y2=“7” id=“f(x) at x=7”/>

As a result, a web interface script can easily invoke methods on objects designed in Flash to obtain meta-media information for display to the user. A sample of such ‘pseudo-code’ follows:

```
Array theTableOfContentEntries =
  FindAllElementsOfClass(“tableOfContentEntry”);
For all items in theTableOfContentEntries {
ItemIndex = next Element Pointer in theTableOfContentEntries;
Build HTML table row with table data =
  TheTableOfContentEntries[ItemIndex].id
}
```

The same technique would be applied to individual MathML elements included in the presentation's expression list.

In the example of a textbook project, all the presentations would be assembled into a software database, organized in a fashion similar to that of the original book organization. The database serves to enforce business rules of a commercial enterprise implementing the invention. Students and users requesting access to the content database will be authenticated as having been awarded access to the database content as a result of some formal institutional or business rules.

The filenames of XML presentation files are entered into a software database such as the public domain MySQL relational database engine. Each database table could represent a specific topic such as “Introduction to Matrices”. Each database row would represent information associated with a presentation entry. The columns in the database would include the presentation filename, a list of words describing the key concepts (‘sine wave derivation’), and a list of related presentations (e.g. list of exercises related to an example).

In addition to including a sequential list of all presentations, the database would also include tables to list all primitive media. The database would exist to provide security and version control, as well as provide a structured method for software to access the media requested by software rendering presentations to the user. The database can be presented to the students through server technologies such as PHP scripts. In such a scenario, the student would be granted access to a table containing the content entries of interest. PHP scripts would then transfer information from the server database rows (presentations) for conversion into XHTML streams sent to the student's web browser. The resulting web page would present the student with lists of presentations (examples, concepts, or review questions) that may be viewed. The student can then access the exercise media for his/her selected exercise.

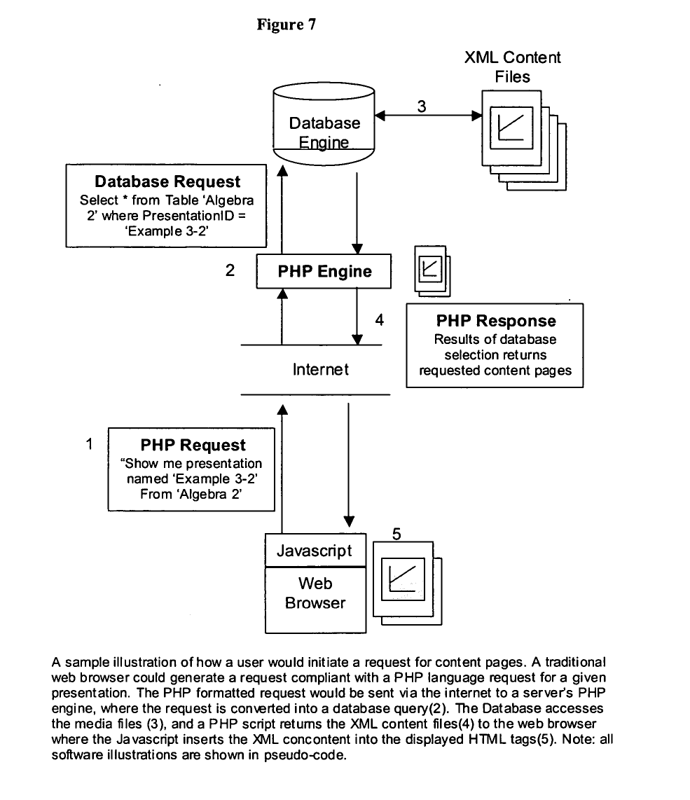

Upon selection of an example problem, the server software would access the XML presentation file to obtain the details of the content to display. FIG. 7. illustrates one possible sequence of technologies that could implement such a sequence.

The same PHP technology referred above would be used to decode the XML file obtained from the database, and build the XHTML constructs that are transferred to the student's invention-enhanced web browser. The underlying mechanics of content display depends on the implementation technique. Expressions that are encoded in MathML can be displayed by many web browsers, as can visualizations that are encoded by SVG constructs. Expressions and visualizations encoded with proprietary authoring tools are rendered by plug-ins provided by the vendor.

On the client side, annotation management software written in a language such as javascript would be embedded in, or referenced by, the XHTML source that is transferred to the client's web browser. The javascript is used to manage the orderly display of the media in the web browser and to manage the user interaction related to annotation and message transfer. Navigation controls on the web page would be used launch javascript commands to communicate back to the server when data for the next display page is required. The client (user's computer) side of this invention includes the support of animation, the illusion of motion or the automated appearance of graphics to add impact to the presentation.

This embodiment conducts the animation through the use of a text-encoded script, each entry providing the id of an expression, visualization, or text narrative div to play a role in the animation sequence. Script entries would also include sufficient information to communicate some time index over which the animation sequence applies as well as the nature of the animation such as manipulation of color or position. These script entries would be encoded in a fashion consistent with the DOM model to allow the annotation management software to control the display sequence. An example of such a script entry to manipulate the color from grey to black of a portion of a MathML document fragment with the id of Step_{—}4 at time indices 35 through 40 follows:

<ScriptEntry val=“35, 40, Step_{—}4, att,mathcolor,#f0f0f0,#000000”/>

The annotation management software would, upon decoding the script entry, manage an internal timer, or sequencer, that would be under control of the invention user. That is, the document would include interface elements (buttons) that would control the sequencing process. An example of a sequence control interface element (implemented as a standard XHTML button element) to step through to time index 18 follows:

<input class=“SequenceControl” type=“button” name=“b1” value=“1” onclick=‘AnnotationManagementSoftware.goToTick(18)’></input>

The time scale for the time indeces listed can be pre-defined (e.g. 1 tick=250 milliseconds), or can be included in some document setup data exchange between the client and the server.

To facilitate interactive discussions about complex subject matter, the invention describes the ability of users to create notes that include annotations referencing various content elements, and to transfer the annotated message to others. FIG. 4 illustrates a sample computer interface to the creation of an annotated message and the exchange of such a message among users.

In any interface supporting the invention, the user views content associated with the individual display pages of a presentation. The student may also use any display page as part of a message to be created and shared by others.

In this sample interface, when a student wishes to generate an annotated message, a “Make Note” button on the web page would instruct the web page software to enter an message creation mode. During such an authoring mode the student is first presented with the display page s/he was viewing when s/he requested to make a note. This note could be implemented as part of a web page as any dynamically (created by the annotation management software) created div element displayed on the web page, the div text content being entered by the user of the invention. Upon completion of the data entry, the student is instructed to select a word in his/her text field to serve as the text anchor of an annotation to be graphically attached (highlighted) to some page content element. The completion of the highlighting process would be supported by annotation management software that could selectively ‘blink’ content elements that are addressable, or display a ‘table of contents’ type of structure to allow the invention user to complete the association with a display page content (see sections on addressability and context). Using this technique, a user of the invention would be able to associate any number of the annotation's text anchors with display page elements. The data captured in the annotation would also include a time or sequence index that represents the point in time of any animation that was in progress when the annotation was created.

The annotated message itself may be implemented as an XML file (XML annotation) that includes:

(a) The message text entered by the user

(b) The annotation ‘anchor’—words or phrases to be used as the trigger for the highlighting

(c) References to the display page element being annotated

(d) The time index in effect when the annotation was created.

A sample annotation in which the word ‘here’ is attached to the left side of an equation could be encoded as the following XML document fragment (the use of the ‘occurrence’ field identifies which occurrence of the token ‘here’ is to be used to anchor the annotation:

<annotated_message content_{—id=“Example}3_{—}13.xml”>

<annotated_message_text>

I don't really understand how the −6 moved to the other side. Didn't it used to be here?

```
    </annotation_message_text>
    <annotation_{—} text_anchor=“here” occurrence=“1” element_id=
“Left side of equation”
    time_index=“18”/>
</annotated_message>
```

Once the user of the invention selects the content page element to be attached to the text anchor, the annotation management software would use standard XHTML attributes to alter the style of the annotation's text to provide a visual indicator that the text in question is an anchor pointing to a display page element.

The final step in displaying the message's annotation consists of a series of ‘rays’, or connections between the annotation anchor and a highlight attached to text, formula, or animation frame. This would be accommodated by the annotation management software that would issue commands to the web browser to draw the connectors between the anchor and elements. The technique could be implemented through scripts that obtain the positional information of the text anchor and the associated display page element through the previously described DOM interface. That software would then modify the XHTML by adding lines, rules, or other graphic elements to the document, with one end of the highlight graphically connected to the annotation's text anchor, the other end graphically connected to the display page element.

The invention may further include that messages be easily transferred among other users of the invention. The use of a text document standard such as XML to capture annotation information allows ready transfer of the information through traditional electronic mail to any other user of the invention. Upon receipt of the XML annotation, a second user's invention enhanced web-based e-mail client would use scripting languages, applets, or other software to decode the XML annotation as received, and reconstruct the annotated display page. The transfer of the annotated message text to a user of the invention results in the XML text sent through any traditional electronic mail mechanism. As previously mentioned, the receipt and proper viewing of the annotation would be managed by a standard web-browser core engine, enhanced by plug-in software sensitive to the requirements of expression and annotation data. Once verification processes indicate that the user authorized to access content database, the database engine and server based PHP engine would transfer the presentation content as had previously been described under Content Display. Upon completion of the content transfer, the client annotation management software would decode the annotation data to determine if the content included an animation that needed to be sequenced to the specified time index. Following graphic manipulation to the specified (if any) time index, the annotation management software would then add the annotation text, highlight the content elements, and draw any connectors as previously described.

FIG. 7 sketches out a collection of technologies that could be used to implement the invention.

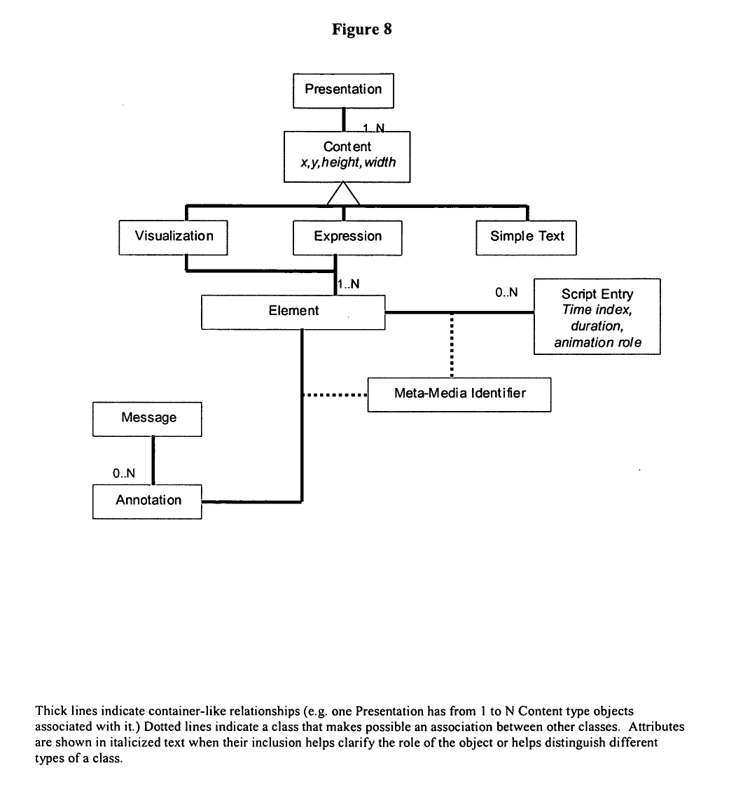

FIG. 8 represents a conceptual view using the Unified Modeling Language to represent the data structures or classes that could implement the invention.

While the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. A method of annotating electronic messages with reference to electronically displayed documents comprising the steps of:
providing on a visual display an electronic document comprising a page of displayed content, wherein the displayed content comprises a plurality of subject items;
encoding a plurality of the subject items in a computer readable format;
displaying a list of encoded, subject items;
choosing an encoded, subject item;
connecting to the chosen item a text annotation;
displaying the text annotation and its connection to the chosen item;
whereby the annotation and its connection to the chosen item is adapted to be displayed on a plurality of visual displays without regard to specific visual display technologies.

2. A method as described in claim 1, wherein the subject items comprise narrative text.

3. A method as described in claim 1, wherein the subject items comprise a sequence of a mathematic or chemical expression.

4. A method as described in claim 1, wherein the subject items comprises a data visualization comprising a collection of displayed graphic elements.

5. A method as described in claim 1, wherein the connection of the text annotation to the chosen item is a graphical connection.

6. A method as described in claim 1, wherein the encoded, computer readable format comprises a meta-media identifier.

7. A method as described in claim 1, wherein the encoding step further comprises encoding a time index representing the subject items' temporal position during an animated playback.

8. A method as described in claim 1, further comprising the step of highlighting the list of encoded, subject items that may be chosen.

9. A method as described in claim 1, further comprising the step of manually selecting the encoded, subject item.

10. A method as described in claim 1, further comprising choosing a plurality of encoded subject items and connecting to the chosen items a corresponding plurality of text annotations.

11. A method as described in claim 1, further comprising the step of distributing the text annotation and its connection to the chosen item to another visual display at a remote location.
